(19) United States
(12) Patent Application Publication
(10) Pub. No.: US 2008/0145096 A1
(43) Pub. Date: Jun. 19, 2008

(54) Two-Part Process Cartridege And Its Assembly/Disassembly

(76) Inventor: Samuel Tsui, Hong Kong (CN)

Correspondence Address: BERENATO, WHITE & STAVISH, LLC, 6550 ROCK SPRING DRIVE, SUITE 240, BETHESDA, MD, 20817, US

(21) Appl. No.: 11/795,973

(22) PCT Filed: Jan. 25, 2006
(86) PCT No.: PCT/AU06/00078

§ 371 Date: Jul. 25, 2007

(30) Foreign Application Priority Data
Jan. 25, 2005 (AU) 2005900299

(51) Int. Cl. G03G 21/18

(52) U.S. Cl. 399/113

(57) ABSTRACT

A two-part construction cartridge 10 comprising a first part 18 having first alignment means 28; a second part 16 having second alignment means 22; a connecting pin 32; and a guiding means 36 forming part of the first alignment means 28. The first alignment means 28 and second alignment means 22 each have an aperture 26, 30 provided therein to securely receive the connecting pin 32 when properly aligned. In this manner, the first unit 18 is connected with the second unit 16. When the connecting pin 32 is forced in the direction of the guiding means 36, upon exiting the apertures 26, 30 the connecting pin 32 is guided by the guiding means 36 to a position where the connecting pin 32 can be recovered for future re-use.

### FIELD OF THE INVENTION

The invention relates to a two-part construction cartridge. In particular, the means provides for easy disassembly of the two-parts of the cartridge to facilitate maintenance and/or refurbishment.

### BACKGROUND TO THE INVENTION

The following discussion of the background of the invention is intended to facilitate an understanding of the present invention. However, it should be appreciated that the discussion is not an acknowledgment or admission that any of the material referred to was published, known or part of the common general knowledge in any jurisdiction as at the priority date of the application.

Process cartridges may be constructed of two parts. The first part is commonly referred to as the developer unit due to its housing of the developer roller and toner. The second part is commonly referred to as the drum unit due to its housing of the photosensitive drum. The developer unit is commonly rotatably connected to the drum unit by way of a connecting member in the form of a cylindrical bar.

The problem with this method of construction is that in seeking to recycle the cartridge, the removal of the connecting member often causes damage to the drum unit.

U.S. Pat. No. 6,327,448 sought to solve this problem by creating a connecting member that has a head slightly smaller than the shaft of the connecting member. This size differences allows the connecting member to be extracted using a specialist tool. Attempts to remove the connecting member without this specialist tool present the same problem of damage often being caused to the drum unit.

It is therefore an object of the present invention to provide a configuration that allows a drum unit to be connected to a developer unit in a manner that overcomes, or at least ameliorates in part, the above-mentioned problem.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the invention there is provided a two-part construction cartridge comprising:
a first part having first alignment means; and
a second part having second alignment means;
a connecting pin; and
a guiding means forming part of the first alignment means,
   where the first alignment means and second alignment means each have an aperture provided therein to securely receive the connecting pin when properly aligned and thereby connect the first part with the second part and where, when the connecting pin is forced in the direction of the guiding means, upon exiting the apertures provided in the first and second alignment means, the connecting pin is guided by the guiding means to a position where the connecting pin can be recovered for future reuse.

The guiding means may be a flange that guides the connecting pin to the base of the first part. Alternatively, the guiding means is a housing that contains the pin. If the guiding means is a housing, the housing may be detachable. Further, in a preferred embodiment, the size of the housing in the direction of force is less than the axial length of the connecting pin.

The first alignment means may consist of at least two ribs and the second alignment means adapted to be received within the space that extends between the two ribs. Alternatively, the first and second alignment means may each include a cog having teeth designed to engage with one another.

Ideally, when the connecting pin is securely received within the apertures of the first and second alignment means, the first and second parts still have a degree of freedom of rotational movement in respect to one another,

In its most preferred embodiment, the first part is a developer unit and the second part is a drum unit.

In accordance with a second aspect of the present invention there is a method for connecting two-part construction cartridges comprising the steps of:
aligning an aperture in the first alignment means with an aperture provided in the second alignment means; and
securely receiving within the aligned apertures a connecting pin,
   such that, when the connecting pin is forced in the direction of a guiding means forming part of the alignment means, upon exiting the aligned apertures the connecting pin is guided by the guiding means to a position where the connecting pin can be recovered for future re-use.

In accordance with a third aspect of the present invention there is a method for disassembling a two-part construction cartridge connected by a connecting pin securely received within aligned apertures in a first alignment means and a second alignment means, the first alignment means also having guiding means, the method comprising the steps of: p1 forcing the connecting pin in the direction of the guiding means to exit the aligned apertures; and
guiding the connecting pin upon exit from the aligned apertures to a position where the connecting pin can be recovered for future re-use.

### BRIEF DESCRIPTION OF THE DRAWINGS

The invention will now be described, by way of example only, with reference to the accompanying drawings, in which:

FIG. 1 is an isometric view of a connecting end-plate for a developer unit,

FIG. 2 is an isometric view of a drum unit.

FIG. 3 is a cross-sectional view of a connection configuration the subject of a first embodiment of the present invention for rotatably connecting a connecting end-plate as shown in FIG. 1 with the drum unit as shown in FIG. 2.

FIG. 4 is a cross-sectional view of a connection configuration the subject of a second embodiment of the present invention.

### PREFERRED EMBODIMENTS OF THE INVENTION

In accordance with a first embodiment of the invention there is a connection configuration 10 for a process cartridge 12. The connection configuration 10 rotatably connects a developer unit 16 to a drum unit 18.

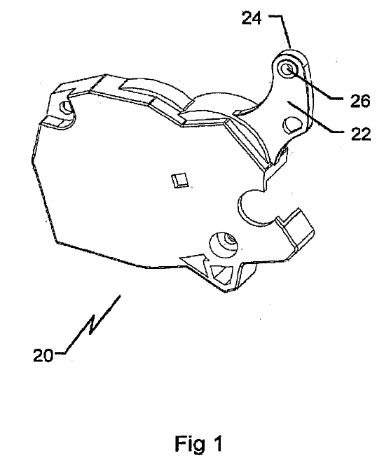

FIG. 1 shows a connecting end-plate 20 for the developer unit 16. The connecting end-plate 20 is adapted to attach to the developer unit 16 by screws.

The connecting end-plate 20 has an elbow 22 extending therefrom. At the exposed end 24 of the elbow 22 is a first retaining aperture 28.

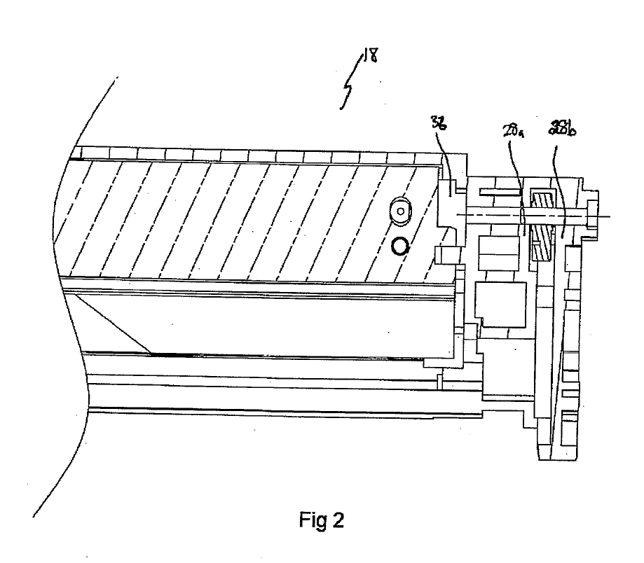

FIG. 2 shows the drum unit 18. The drum unit 18 has two ribs 28 extending therefrom. The ribs 28 are spaced from one another to accommodate the elbow 22 when the drum unit 18 and developer unit 16 are connected. The distance between the ribs 28 is substantially equal to the width of the elbow 22.

Each rib 28 also has a second retaining aperture 30 provided therein. The position of the second retaining apertures 30 are such that when the elbow is received within the space provided for between the ribs, the centres of the retaining apertures 26, 30 are co-axial. The size of the retaining apertures 26, 30 is equal to the diameter of a connecting pin 32.

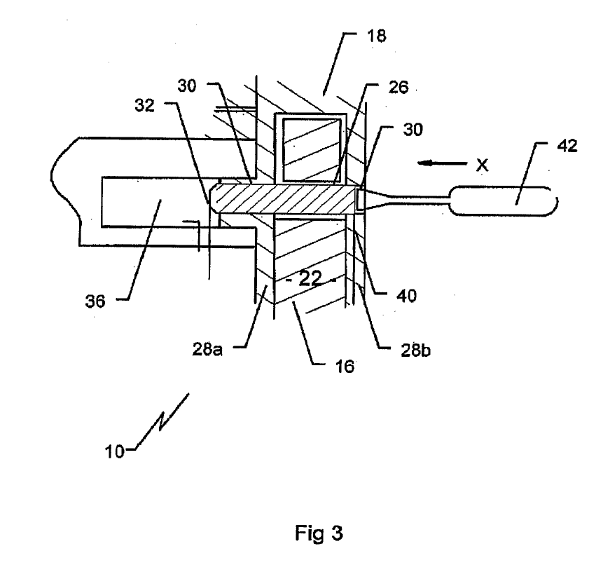

As shown more clearly in FIG. 3, attached to a first side 34 of the interior rib 28a is a pin housing 36. The connection configuration 10 and the role of the pin housing 36, Will now be described in more detail below in the context of its intended use.

The developer unit 16 is placed alongside the drum unit 18. The elbow 22 of the connecting end-plate 20 of the developer unit 16 is aligned with the ribs 28 of the drum unit 18. The developer unit 16 is then rotated such that the elbow 22 is received within the space provided between the ribs 28. This reception is secure, but not to an extent that freedom of rotational movement of the developer unit 16 relative to the drum unit 18 is inhibited.

In this position, as mentioned above, the retaining apertures 26, 30 are in alignment. This allows for connecting pin 32 to be inserted into the retaining apertures 26, 30 and thereby form a permanent rotatable connection between the developer unit 16 and the drum unit 18.

The connecting pin 32 need not be of any special type. Further, the connecting pin 32 can be inserted so that it is flush, or recessed with a second side 40 of the exterior rib 28b.

To allow disassembly of the process cartridge 12 formed by the connection of the developer unit 16 and the drum unit 18, the user acquires a tool 42. The tool 42 may be any broad-head tool, such as a flat head screwdriver, or may be a make-shift tool with a point, such as a ball-point pen. The only restriction is that the head or point of the tool 42 must be of equal or lesser size than the diameter of the connecting pin 32.

The user positions the tool 42 such that it is connected with an exposed portion 44 of the connecting pin 32. Pressure is then applied to the tool 42 in the direction marked X. This pressure moves the connecting pin 32 towards the pin housing 36. This movement first causes the developer unit 16 and the drum unit 18 to be connected only through first retaining aperture 26 and the second retaining aperture 30 of interior rib 28a. As further pressure is applied, the connecting pin 32 is no longer retained within first retaining aperture 26 thereby allowing the developer unit 16 to be disconnected from the drum unit 18. As is evidenced, in this method, no damage is caused to either the developer unit 16 or the drum unit 18.

Following disconnection of the developer unit 16 from the drum unit 18, the connecting pin 32 is retained within the pin housing 36. This allows the connecting pin 32 to be reused when the developer unit 16 and drum unit 18 are reconnected following refurbishment and/or cleaning of the process cartridge 12.

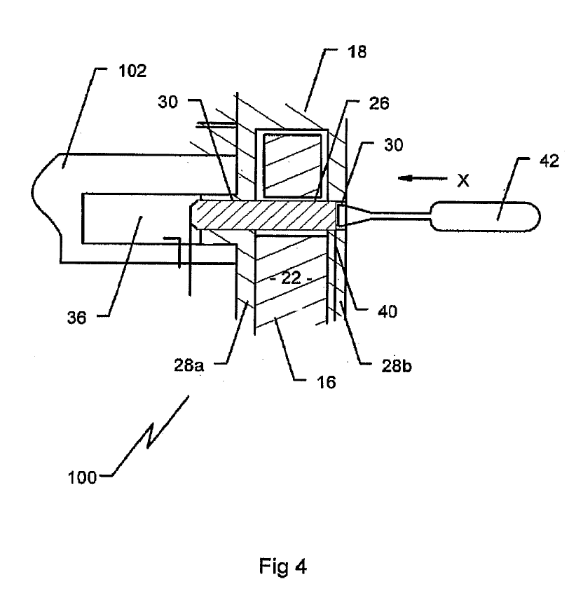

In accordance with a second embodiment of the invention, where like numerals reference like parts, there is a connection configuration 100 for a process cartridge 12. The connection configuration 100 is identical to the connection configuration 10, except that the pin housing 36 is replaced with a flange 102. This embodiment is illustrated in FIG. 4.

In this embodiment, flange 102 operates to deflect the connecting pin 32 to the base of the process cartridge 12 following its removal from the retaining apertures 26, 30. The connecting pin 32 can then be recovered during refurbishment and/or cleaning of the process cartridge 12.

It should be appreciated by the person skilled in the art that the above invention is not limited to the embodiment described. In particular, the following modifications and improvements may be made without departing from the scope of the present invention:
The pin housing 36 may be smaller than the axial length of the connecting pin 32. In this situation the pin housing 36 relative to the connecting pin 32 should be such as to allow the connecting pin 38 to be removed from the pin housing 36 following disconnection—whether this be by detaching the pin housing 36 from the interior rib 28a or by rotation of the drum housing 18 to a position where the connecting pin 32′slides out by way of gravity.
The rib 28 configuration of the drum unit 18 described above may be replaced with other alignment mechanisms. These connection mechanisms may not allow freedom of rotational movement between the drum unit 18 and the developer unit 16. For instance, the drum unit 18 may have a cog having teeth that interlock with the teeth of a cog provided an the developer unit 16, such that the two units are properly aligned (the space between the interlocking teeth able to determine the degree of freedom of rotational movement between the drum unit 18 and the developer unit 16).

It should be further appreciated by the person skilled in the art that the features described in one embodiment, where not mutually exclusive or alternatives, may be combined with features described in other embodiments to create yet further embodiments that fall within the scope of the present invention.

1. A two-part construction cartridge comprising:
a first part having first alignment means; and
a second part having second alignment means;
a connecting pin; and
a guiding means forming part of the first alignment means, where the first alignment means and second alignment means each have an aperture provided therein to securely receive the connecting pin when properly aligned and thereby connect the first part with the second part and where, when the connecting pin is forced in the direction of the guiding means, upon exiting the apertures provided in the first and second alignment means, the connecting pin is guided by the guiding means to a position where the connecting pin can be recovered for future re-use.

2. A two-part construction cartridge according to claim 1, where the guiding means is a flange that guides the connecting pin to the base of the first part.

3. A two-part construction cartridge according to claim 1, where the guiding means is a housing that contains the pin.

4. A two-part construction cartridge according to claim 3, where the housing is detachable.

5. A two-part construction cartridge according to claim 3, where the size of the housing in the direction of force is less than the axial length of the connecting pin.

6. A two-part construction cartridge according to claim 1, where the first alignment means has at least two ribs and the second alignment means is adapted to be received within the space that extends between the two ribs.

7. A two-part construction cartridge according to claim 1, where the first and second alignment means each include a cog having teeth designed to engage with one another.

8. A two-part construction cartridge according to claim 1, where when the connecting pin is securely received within the apertures of the first and second alignment means, the first and second parts still have a degree of freedom of rotational movement in respect to one another.

9. A two-part constructed process cartridge according to claim 1 where the first part is a developer unit and the second part is a drum unit.

10. A method for connecting two-part construction cartridges comprising the steps of:
aligning an aperture in the first alignment means with an aperture provided in the second alignment means; and
securely receiving within the aligned apertures a connecting pin, such that, when the connecting pin is forced in the direction of a guiding means forming part of the alignment means, upon exiting the aligned apertures the connecting pin is guided by the guiding means to a position where the connecting pin can be recovered for future re-use.

11. A method for disassembling a two-part construction cartridge connected by a connecting pin securely received within aligned apertures in a first alignment means and a second alignment means, the first alignment means also having guiding means, the method comprising the steps of:
forcing the connecting pin in the direction of the guiding means to exit the aligned apertures; and
guiding the connecting pin upon exit from the aligned apertures to a position where the connecting pin can be recovered for future re-use.

12-14. (canceled)
